(19) United States
(12) Patent Application Publication
(10) Pub. No.: US 2026/0066351 A1
(43) Pub. Date: Mar. 5, 2026

(54) ELECTROLYTE COMPOSITION, AND BATTERY AND DEVICE INCLUDING THE SAME

(71) Applicant: GM Global Technology Operations LLC, Detroit, MI (US)

(72) Inventors: Chuanlong Wang, Troy, MI (US); Mengyuan Chen, Madison Heights, MI (US); Xiaosong Huang, Novi, MI (US); Zhongyi Liu, Troy, MI (US); Bradley R. Frieberg, Farmington Hills, MI (US)

(73) Assignee: GM GLOBAL TECHNOLOGY OPERATIONS LLC, Detroit, MI (US)

(21) Appl. No.: 18/822,929

(22) Filed: Sep. 3, 2024

(51) Int. Cl. H01M 10/0569; H01M 4/02; H01M 4/131; H01M 4/505; H01M 4/525; H01M 10/0568

(52) U.S. Cl. CPC H01M 10/0569; H01M 4/131; H01M 4/505; H01M 4/525; H01M 10/0568; H01M 2004/028; H01M 2300/0034; H01M 2300/0051

(57) ABSTRACT

An electrolyte composition for batteries is provided. The electrolyte composition includes a solvent including one or more fluorinated carbonates. The electrolyte composition further includes a lithium-based salt and a lithium (oxalato)borate salt. Additionally, a battery including the electrolyte composition is provided. The battery includes an anode, a nickel-based cathode, and the electrolyte composition disposed between the anode and the nickel-based cathode.

### INTRODUCTION

The disclosure generally relates to an electrolyte composition for batteries.

Battery cells may include an anode, a cathode, an electrolyte composition, and a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A battery cell includes an electrolyte composition which provides lithium-ion conduction paths between the anode and the cathode. The electrolyte is an ionic conductor. The electrolyte is additionally an electronically insulating material.

One of the factors that determines the commercial viability of a battery cell is its capacity and cycling tolerance. A battery cell(s) for an automotive vehicle with an electric-drive powertrain may be tasked to provide at least 30,000 hours of service. Such high requirements may present a challenge to the vehicle's battery cell(s).

### SUMMARY

An electrolyte composition for batteries in accordance with one or more embodiments is provided. The electrolyte composition includes a solvent, a lithium-based salt, and a lithium (oxalato)borate salt. The solvent includes one or more fluorinated carbonates.

In some embodiments, the lithium (oxalato)borate salt is chosen from LiDFOB, LiBOB, or a combination thereof.

In some embodiments, the lithium (oxalato)borate salt is LiDFOB.

In some embodiments, the one or more fluorinated carbonates is chosen from FEC, FEMC, bis (2,2,2-trifluoroethyl) carbonate (FDEC), 3,3,3-trifluoropropylene carbonate (TFPC), dichloroethylene carbonate, or a combination thereof.

In some embodiments, the one or more fluorinated carbonates includes FEC and a second fluorinated carbonate chosen from FEMC, bis (2,2,2-trifluoroethyl) carbonate (FDEC), 3,3,3-trifluoropropylene carbonate (TFPC), dichloroethylene carbonate, or a combination thereof.

In some embodiments, the second fluorinated carbonate is FEMC.

In some embodiments, the lithium-based salt is chosen from lithium hexafluorophosphate (LiPF₆), lithium tetrafluoroborate, lithium bis(fluorosulfonyl)imide, lithium bis(trifluoromethanesulfonyl)imide, or a combination thereof.

In some embodiments, the lithium-based salt includes LiPF6.

In some embodiments, the lithium-based salt is present in the electrolyte composition in a molar concentration of from about 0.5 to about 1.5 molarity (M).

In some embodiments, the solvent includes FEC and FEMC that are present in a weight ratio of FEC:FEMC of about 1:9.

In some embodiments, the lithium (oxalato)borate salt is present in an amount of from about 0.5 to about 1.0 wt. % based on the electrolyte composition.

A battery in accordance with one or more embodiments is provided. The battery includes an anode, a nickel-based cathode, and an electrolyte composition that is disposed between the anode and the nickel-based cathode. The electrolyte composition includes a solvent, a lithium-based salt, and a lithium (oxalato)borate salt. The solvent includes one or more fluorinated carbonates.

In some embodiments, the nickel-based cathode includes Li, Ni, Co, Mn, and O.

In some embodiments, the nickel-based cathode includes a nickel-based cathode active material that includes Ni present in an amount of about 60 wt. % or greater of the nickel-based cathode active material.

In some embodiments, the nickel-based cathode includes a nickel-based cathode active material having a formula of LiNi_{0.8}Co_{0.1}Mn_{0.1}O₂.

In some embodiments, the anode includes SiOₓ/graphite, graphite, Si, SiOₓ, lithium metal, or a combination thereof, and wherein x is a value greater than 0.

In some embodiments, the lithium (oxalato)borate salt is chosen from LiDFOB, LiBOB, or a combination thereof.

In some embodiments, the one or more fluorinated carbonates includes FEC and a second fluorinated carbonate chosen from FEMC, bis (2,2,2-trifluoroethyl) carbonate (FDEC), 3,3,3-trifluoropropylene carbonate (TFPC), dichloroethylene carbonate, or a combination thereof.

In some embodiments, the lithium-based salt includes LiPF₆.

A device in accordance with one or more embodiments is provided. The device includes an output component and a battery that is configured for providing electrical energy to the output component. The battery includes an anode, a nickel-based cathode, and an electrolyte composition that is disposed between the anode and the nickel-based cathode. The electrolyte composition includes a solvent that includes one or more fluorinated carbonates chosen from FEC, FEMC, bis (2,2,2-trifluoroethyl) carbonate (FDEC), 3,3,3-trifluoropropylene carbonate (TFPC), dichloroethylene carbonate, or a combination thereof. The electrolyte composition further includes a lithium-based salt chosen from lithium hexafluorophosphate (LiPF₆), lithium tetrafluoroborate, lithium bis(fluorosulfonyl)imide, lithium bis(trifluoromethanesulfonyl)imide, or a combination thereof. The lithium-based salt is present in the electrolyte composition in a molar concentration of from about 0.5 to about 1.5 molarity (M). The electrolyte composition further includes a lithium (oxalato)borate salt chosen from LiDFOB, LiBOB, or a combination thereof. The lithium (oxalato)borate salt is present in an amount of from about 0.5 to about 1.0 wt. % based on the electrolyte composition.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary battery cell including an anode, a cathode, a separator, and an electrolyte composition, in accordance with the present disclosure;

FIG. 2 schematically illustrates an exemplary device including a battery pack including a plurality of battery cells, in accordance with the present disclosure;

FIG. 3A-3C schematically illustrate an enlarged area of the cathode interfacing with the electrolyte depicted in FIG. 1 at various stages of the formation of a solid electrolyte interface (SEI), in accordance with the present disclosure; and

FIG. 4 is a graph illustrating Differential Scanning Calorimetry (DSC) test results of cathode thermal release in the presence of different electrolytes, in accordance with the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

High-capacity and high-power nickel-based cathode materials are useful for a lithium-ion energy storage system powering a battery electric vehicle. Such an energy storage system may be described as a high energy density battery. The battery cells may include a graphite-containing and/or silicon-containing anode and a nickel-based cathode.

A capacity and cycling tolerance of the battery cells may vary according to operating conditions. Battery cell performance may vary according to cathode and anode material selection. An electrolyte composition disclosed herein provides excellent cycle life for the battery cells. In one embodiment, the electrolyte composition includes a solvent including one or more fluorinated carbonates, a lithium-based salt, and a lithium (oxalato)borate salt. In one or more embodiments of the disclosure, the lithium (oxalato)borate salt is present in an amount of from about 0.5 to about 1 wt. %, based on a total weight of the electrolyte composition.

Testing has shown that addition of lithium (oxalato)borate salt in the described weight percentages improves solid electrolyte interface (SEI) formation on the electrode(s), or more specifically cathode electrolyte interface (CEI) formation on the nickel-based cathode. A CEI results from a chemical reaction between the nickel-based cathode and a liquid or gel electrolyte interacting with the cathode. The CEI forms as a film upon the nickel-based cathode and has been found to improve the cycle life for the battery cell.

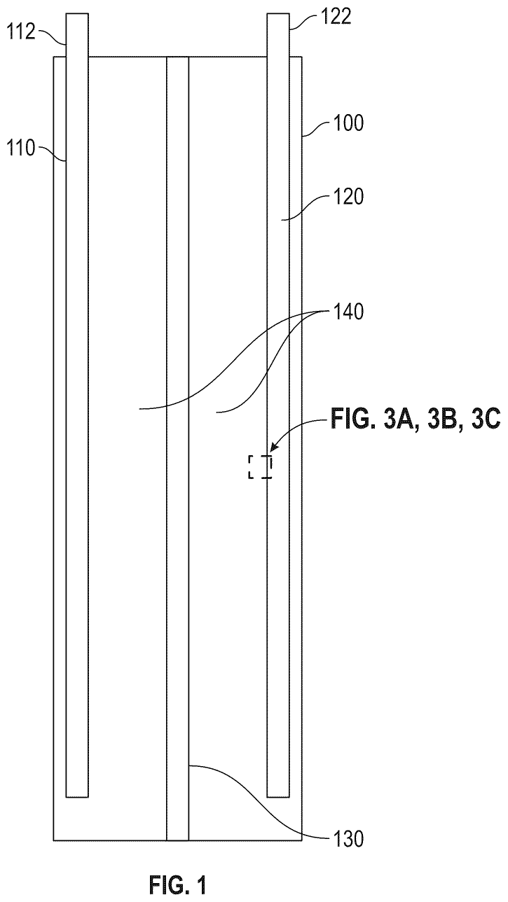

Referring now to the drawings, wherein like reference numbers refer to like features throughout the several views, FIG. 1 schematically illustrates an exemplary battery cell 100, including an anode 110, a cathode 120, a separator 130, and an electrolyte composition 140. The battery cell 100 enables converting electrical energy into stored chemical energy in a charging cycle, and the battery cell 100 enables converting stored chemical energy into electrical energy in a discharging cycle. A negative current collector 112 is illustrated connected to the anode 110, and a positive current collector 122 is illustrated connected to the cathode 120. The separator 130 is operable to separate the anode 110 from the cathode 120 and to enable ion transfer through the separator 130. The electrolyte composition 140 is a liquid or gel that provides a lithium-ion conduction path between the anode 110 and the cathode 120.

The anode 110 may be constructed of silicon, a silicon alloy, or other silicon-containing material (e.g., SiOₓ wherein x is a value greater than 0) and/or a graphite or graphite-containing material and/or lithium metal. In an exemplary embodiment, the cathode 120 is a nickel-based cathode that includes a nickel-based cathode active material. The nickel-based cathode active material includes Ni present in an amount of about 60 wt. % or greater of the nickel-based cathode active material. In an exemplary embodiment, the nickel-based cathode includes Li, Ni, Co, Mn, and O. In one embodiment, the nickel-based cathode active material has a formula of LiNi_{0.8}Co_{0.1}Mn_{0.1}O₂.

In one or more embodiments of the disclosure, the electrolyte composition 140 includes a solvent, a lithium-based salt, and a lithium (oxalato)borate salt. The solvent includes one or more fluorinated carbonates, such as fluoroethylene carbonate (FEC), 2,2,2-trifluoroethyl methyl carbonate (FEMC), bis (2,2,2-trifluoroethyl) carbonate (FDEC), 3,3,3-trifluoropropylene carbonate (TFPC), and/or dichloroethylene carbonate. In an exemplary embodiment, the solvent includes FEC as a first fluorinated carbonate and a second fluorinated carbonate such as FEMC, bis (2,2,2-trifluoroethyl) carbonate (FDEC), 3,3,3-trifluoropropylene carbonate (TFPC), and/or dichloroethylene carbonate. In one embodiment, the second fluorinated carbonate is FEMC. In an exemplary embodiment, the solvent includes FEC and FEMC that are present in a weight ratio of FEC:FEMC of about 1:9. Optionally, the FEC:FEMC ratio is between 1:19 and 1:4. Optionally, the FEC:FEMC ratio is between 1:19 and 1:2.

In an exemplary embodiment, the lithium (oxalato)borate salt is chosen from lithium difluoro(oxalato)borate (LiDFOB) and/or lithium bix(oxalato)borate (LiBOB). In one embodiment, the lithium (oxalato)borate salt is LiDFOB. In an exemplary embodiment, the lithium (oxalato)borate salt is present in an amount of from about 0.5 to about 1.0 wt. %, based on the total weight of the electrolyte composition 140. Optionally, the lithium (oxalate)borate salt is present in an amount from about 0.2 to about 2.0 wt%.

In an exemplary embodiment, the lithium-based salt is chosen from lithium hexafluorophosphate (LiPF₆), lithium tetrafluoroborate, lithium bis(fluorosulfonyl)imide, lithium bis(trifluoromethanesulfonyl)imide, or a combination thereof. In one embodiment, the lithium-based salt includes or is LiPF₆. In an exemplary embodiment, the lithium-based salt is present in the electrolyte composition 140 in a molar concentration of from about 0.5 to about 1.5 molarity (M).

The electrolyte composition 140 may further include other co-additives. For example, the electrolyte composition 140 may further include one or more phosphorous-and silicon-based additives. Non-limiting examples of phosphorus-and silicon-based additives include tris(trimethylsilyl) phosphite and/or tris(trimethylsilyl) phosphate. In an exemplary embodiment, the one or more phosphorous-and silicon-based additives is present in an amount of from about 0.1 to about 2 wt. %, based on a total weight of the electrolyte composition 140. Other possible electrolyte additives include polymerizable additives such as: vinylene carbonate (VC), vinyl ethylene carbonate (VEC), allyl ethyl carbonate, vinyl acetate, maleic anhydride, 2-vinyl pyridine, lithium difluorophosphate (LiPO₂F₂), 1,3,2-dioxathiolane 2,2-dioxide (DTD), dimethylacrylamide, tris(trimethylsilyl) phosphite, and the like.

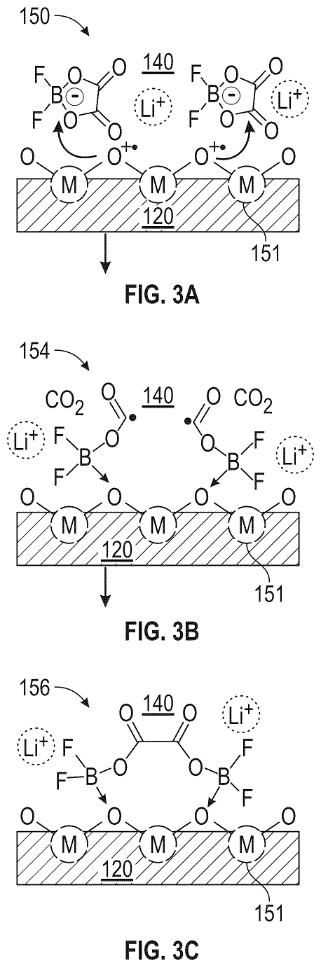

Referring also to FIGS. 3A-3C, as discussed above, the lithium (oxalato)borate salt 150 in the described weight percentages improves solid electrolyte interface (SEI) formation, specifically cathode electrolyte interface (CEI) 156 formation on the cathode 120. In particular, the lithium (oxalato)borate salt 150 interacts with the metal oxides 151 on the cathode 120 (shown in FIG. 3A) to form an intermediate product 154 (shown in FIG. 3B) that further reacts to form the CEI 156 as a protective layer to create a more stable interface along the cathode 120 that protects the metal oxide 151 bonds to prevent or minimize the release of oxygen (O) to mitigate a thermal runaway event.

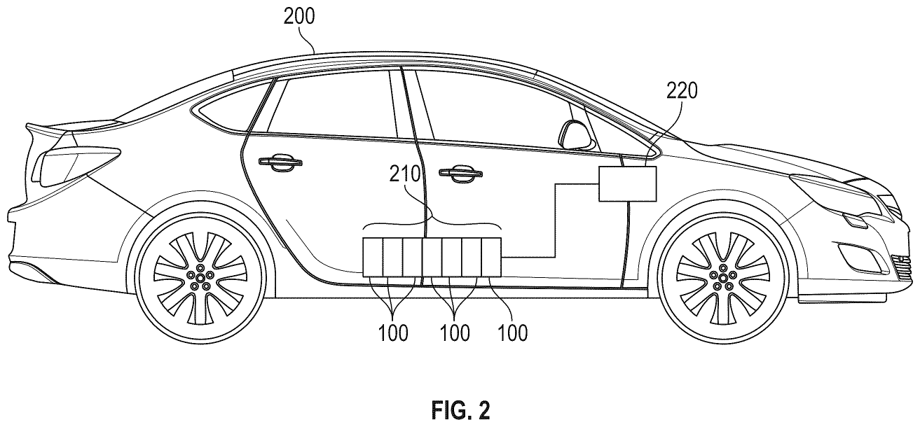

The battery cell 100 may be utilized in a wide range of applications and powertrains. FIG. 2 schematically illustrates an exemplary device 200, e.g., a battery electric vehicle (BEV), including a battery pack 210 that includes a plurality of battery cells 100. The plurality of battery cells 100 may be connected in various combinations, for example, with a portion being connected in parallel and a portion being connected in series, to achieve goals of supplying electrical energy at a desired voltage. The battery pack 210 is illustrated as electrically connected to a motor generator unit 220 useful to provide motive force to the vehicle 200. The motor generator unit 220 may include an output component, for example, an output shaft, which is provided mechanical energy useful to provide the motive force to the vehicle 200. A number of variations to vehicle 200 are envisioned, and the disclosure is not intended to be limited to the examples provided.

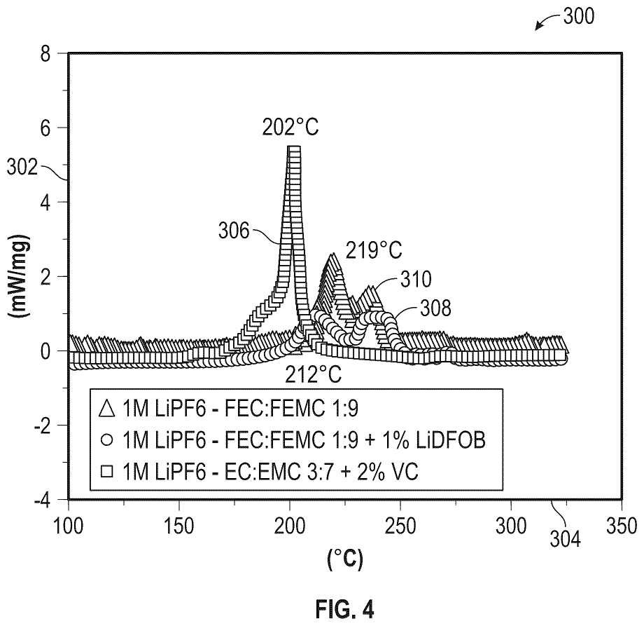

FIG. 4 is a graph 300 illustrating Differential Scanning Calorimetry (DSC) test results of cathode thermal release in the presence of different electrolytes in accordance with the present disclosure. A vertical axis 302 is illustrated describing heat flow in units of mW/mg. A horizontal axis 304 is illustrated describing temperature in units of Celsius (°C).

As illustrated, line 306 represents an electrolyte composition including LiPF₆ in EC:EMC 3:7+2% VC as a first control electrolyte composition, line 308 represents an electrolyte composition including LiPF₆ in FEC:FEMC 1:9+1% LiDFOB as a second electrolyte composition, and line 310 represents an electrolyte composition including LiPF₆ in FEC:FEMC 1:9 as a third electrolyte composition. Comparing the electrolyte compositions 308, 310 with the control electrolyte composition 306, it can be seen that FEC and FEMC largely enhance the thermal stabilities of the electrolyte compositions.

For example, the peak temperatures of the electrolyte compositions are correspondingly delayed by either 10° C. or 17° C., and the total heat release is reduced by either 21% or 24%, based on the total heat released for the electrolyte composition 306 of 721 J/g, the electrolyte composition 308 of 566 J/g, and the electrolyte composition 310 of 545 J/g.

While the best modes for carrying out the disclosure have been described in detail, those familiar with the art to which this disclosure relates will recognize various alternative designs and embodiments for practicing the disclosure within the scope of the appended claims.

What is claimed is:

1. An electrolyte composition for batteries, the electrolyte composition comprising:
a solvent comprising one or more fluorinated carbonates;
a lithium-based salt; and
a lithium (oxalato)borate salt.

2. The electrolyte composition of claim 1, wherein the lithium (oxalato)borate salt is chosen from LiDFOB, LiBOB, or a combination thereof.

3. The electrolyte composition of claim 1, wherein the lithium (oxalato)borate salt is LiDFOB.

4. The electrolyte composition of claim 1, wherein the one or more fluorinated carbonates is chosen from FEC, FEMC, bis (2,2,2-trifluoroethyl) carbonate (FDEC), 3,3,3-trifluoropropylene carbonate (TFPC), dichloroethylene carbonate, or a combination thereof.

5. The electrolyte composition of claim 1, wherein the one or more fluorinated carbonates comprises FEC and a second fluorinated carbonate chosen from FEMC, bis (2,2,2-trifluoroethyl) carbonate (FDEC), 3,3,3-trifluoropropylene carbonate (TFPC), dichloroethylene carbonate, or a combination thereof.

6. The electrolyte composition of claim 5, wherein the second fluorinated carbonate is FEMC.

7. The electrolyte composition of claim 1, wherein the lithium-based salt is chosen from lithium hexafluorophosphate (LiPF₆), lithium tetrafluoroborate, lithium bis(fluorosulfonyl)imide, lithium bis(trifluoromethanesulfonyl)imide, or a combination thereof.

8. The electrolyte composition of claim 1, wherein the lithium-based salt comprises LiPF_{6.}

9. The electrolyte composition of claim 1, wherein the lithium-based salt is present in the electrolyte composition in a molar concentration of from about 0.5 to about 1.5 molarity (M).

10. The electrolyte composition of claim 1, wherein the solvent comprises FEC and FEMC that are present in a weight ratio of FEC:FEMC of about 1:9.

11. The electrolyte composition of claim 1, wherein the lithium (oxalato)borate salt is present in an amount of from about 0.5 to about 1.0 wt. % based on the electrolyte composition.

12. A battery comprising:
an anode;
a nickel-based cathode; and
an electrolyte composition disposed between the anode and the nickel-based cathode, the electrolyte composition comprising:
a solvent comprising one or more fluorinated carbonates;
a lithium-based salt; and
a lithium (oxalato)borate salt.

13. The battery of claim 12, wherein the nickel-based cathode comprises Li, Ni, Co, Mn, and O.

14. The battery of claim 12, wherein the nickel-based cathode comprises a nickel-based cathode active material comprising Ni present in an amount of about 60 wt. % or greater of the nickel-based cathode active material.

15. The battery of claim 12, wherein the nickel-based cathode comprises a nickel-based cathode active material having a formula of LiNi_{0.8}Co_{0.1}Mn_{0.1}O_{2.}

16. The battery of claim 12, wherein the anode comprises SiOₓ/graphite, graphite, Si, SiOₓ, lithium metal, or a combination thereof, and wherein x is a value greater than 0.

17. The battery of claim 12, wherein the lithium (oxalato)borate salt is chosen from LiDFOB, LiBOB, or a combination thereof.

18. The battery of claim 12, wherein the one or more fluorinated carbonates comprises FEC and a second fluorinated carbonate chosen from FEMC, bis (2,2,2-trifluoroethyl) carbonate (FDEC), 3,3,3-trifluoropropylene carbonate (TFPC), dichloroethylene carbonate, or a combination thereof.

19. The battery of claim 12, wherein the lithium-based salt comprises LiPF_{6.}

20. A device comprising:
an output component: and a battery configured for providing electrical energy to the output component, the battery comprising:
an anode;
a nickel-based cathode; and
an electrolyte composition disposed between the anode and the nickel-based cathode, the electrolyte composition comprising:
a solvent comprising one or more fluorinated carbonates chosen from FEC, FEMC, bis (2,2,2-trifluoroethyl) carbonate (FDEC), 3,3,3-trifluoropropylene carbonate (TFPC), dichloroethylene carbonate, or a combination thereof;
a lithium-based salt chosen from lithium hexafluorophosphate (LiPF₆), lithium tetrafluoroborate, lithium bis(fluorosulfonyl)imide, lithium bis(trifluoromethanesulfonyl)imide, or a combination thereof, and wherein the lithium-based salt is present in the electrolyte composition in a molar concentration of from about 0.5 to about 1.5 molarity (M); and
a lithium (oxalato)borate salt chosen from LiDFOB, LiBOB, or a combination thereof, and wherein the lithium (oxalato)borate salt is present in an amount of from about 0.5 to about 1.0 wt. % based on the electrolyte composition.
